(19) United States
(12) Patent Application Publication
(10) Pub. No.: US 2010/0265135 A1
(43) Pub. Date: Oct. 21, 2010

(54) GLOBAL POSITIONING SYSTEM LOGGER

(76) Inventor: En-Min JOW, Hsinchu (TW)

Correspondence Address: Muncy, Geissler, Olds & Lowe, PLLC, 4000 Legato Road, Suite 310, FAIRFAX, VA, 22033, US

(21) Appl. No.: 12/551,989

(22) Filed: Sep. 1, 2009

(30) Foreign Application Priority Data
Apr. 17, 2009 (TW) 98112854

(51) Int. Cl. G01S 19/35; G01S 1/00; G01C 21/00; G01C 21/36

(52) U.S. Cl. 342/357.75; 701/213; 701/211

(57) ABSTRACT

A global positioning system (GPS) logger includes a GPS module, a storage unit, a slot, a communication interface and a processing unit. The GPS module is configured for receiving a satellite signal and generating a log data including a position coordinate and a log time. The storage unit is configured for storing the log data. The slot is configured for an external storage media which stores a file including a time stamp to connect with the GPS logger. The communication interface is configured for an electronic device to electrically connect with the GPS logger so that the electronic device can exchange data with the GPS logger through the communication interface. The processing unit is electrically connected to the foresaid elements and configured for embedding the position coordinate in the file according to the log time and the time stamp while the file stored in the external storage media is accessed.

### BACKGROUND OF THE INVENTION

1. Field of the Invention

The present invention is related to a global positioning system (GPS) logger, and more particularly to a global positioning system (GPS) logger embedding a corresponding coordinate in files while accessing files.

2. Description of the Prior Art

A global positioning system (GPS) is configured to find out a position coordinate of a GPS receiver at present based on received information from a GPS satellite signal. A GPS logger, an example in GPS applications, stores a position coordinate periodically for recording the travel trajectory of a user or a vehicle that is equipped with a GPS receiver. Traveling becomes a popular recreation in recent years; travel trajectories may not only be recorded by users via a GPS logger, but also be used for organizing or sharing taken photographs or films by combining the position coordinate with photographs or films which they took during the travel. For example, an image is shown at the corresponding coordinate on an electronic map.

A conventional method for organizing images by utilizing travel trajectories includes that a user accesses a position coordinate and an image file from a GPS logger and a storage media, respectively, to embed the position coordinate in the image file or generate a mapping file corresponding to the position coordinate and the image file via a specific software, and the user may browse the image according to the position coordinate. However, according to the aforementioned method of integrating a position coordinate with an image file, the user has to connect the GPS logger and the storage media with a computer and then operate the software to proceed, which is not a friendly operation and it is even difficult for users who are not familiar with computer operation.

Therefore, how to simplify the operation of integrating a position coordinate with an image file is a current goal to be achieved.

### SUMMARY OF THE INVENTION

The present invention is directed to provide a global positioning system (GPS) logger which comprises a slot for electrically connecting to an external storage media and embeds a position coordinate in a corresponding file while accessing the file in the external storage media to simplify the operation of integrating a position coordinate with a file.

One embodiment of a global positioning system (GPS) logger according to the present invention comprises a GPS module, a storage unit, a slot, a communication interface and a processing unit. The GPS module is configured to receive a satellite signal to generate a log data including a position coordinate and a log time. The storage unit is configured to store the log data. The slot is configured for an external storage media which is configured to store at least one file including a time stamp to electrically connect with the GPS logger. The communication interface is configured for an electronic device to electrically connect with the GPS logger so that the electronic device may exchange data with the GPS logger via the communication interface. The processing unit is electrically connected to the GPS module, the storage unit, the communication interface and the slot, wherein the processing unit is used for embedding the position coordinate in the file according to the log time and the time stamp while the processing unit is accessing the file stored in the external storage media.

Other advantages of the present invention will become apparent from the following description taken in conjunction with the accompanying drawings wherein are set forth, by way of illustration and example, certain embodiments of the present invention.

### BRIEF DESCRIPTION OF THE DRAWINGS

The foregoing aspects and many of the accompanying advantages of this invention will become more readily appreciated as the same becomes better understood by reference to the following detailed description, when taken in conjunction with the accompanying drawings, wherein:

FIG. 1 is a block diagram schematically illustrating a GPS logger according to one embodiment of the present invention; and

FIG. 2 is a block diagram schematically illustrating a GPS logger according to another embodiment of the present invention.

### DESCRIPTION OF THE PREFERRED EMBODIMENT

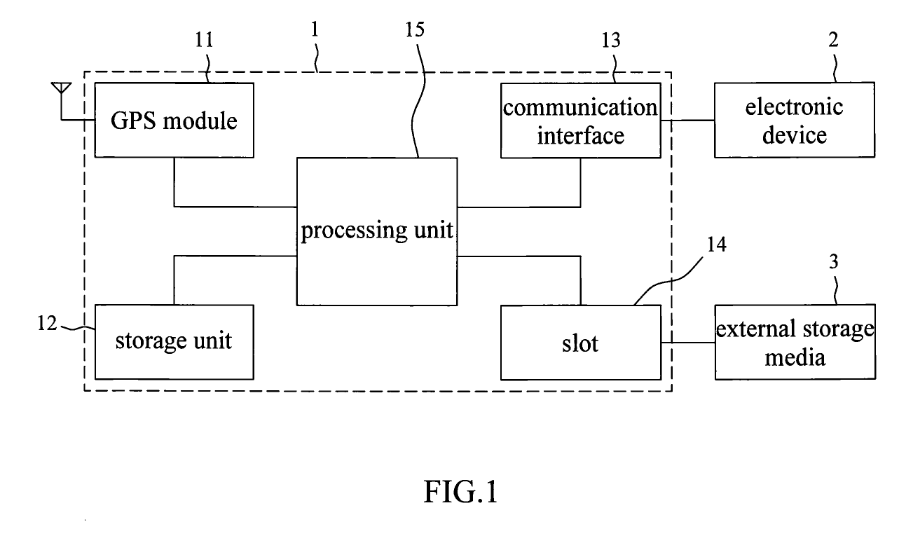

Referring to FIG. 1, one embodiment of a global positioning system (GPS) logger 1 according to the present invention comprises a GPS module 11, a storage unit 12, a communication interface 13, a slot 14, and a processing unit 15. The GPS module 11 is configured to receive a satellite signal and generate a log data. For example, the log data includes a position coordinate and a log time, therefore, user's travel trajectories may be recorded by periodically storing position coordinates in the storage unit 12. For example, the storage unit 12 comprises a flash memory or a hard drive. The slot 14 is configured for an external storage media 3 to electrically connect with the GPS logger 1, wherein at least one file including a time stamp is stored in the external storage media 3. For example, the external storage media 3 comprises a memory card; the file comprises a photograph or a film.

The communication interface 13 is configured for an electronic device 2 to electrically connect with the GPS logger 1 so that the electronic device 2 may exchange data with the GPS logger 1 via the communication interface 13, for example, accessing the data comprising the position coordinate and the log time in the storage unit 12 or the file in the external storage media 3. In one embodiment according to the present invention, the communication interface 13 comprises a wireless communication module, e.g. a wireless local area network, an ultra wideband or a Bluetooth module, or a Universal Serial Bus (USB).

To continue, the processing unit 15 is electrically connected to the GPS module 11, the storage unit 12, the communication interface 13 and the slot 14. According to the log time stored in the storage unit 12 and the time stamp in the file, the processing unit 15 embeds the corresponding position coordinate in the file while the file stored in the external storage media 3 is being accessed. For example, when the file stored in the external storage media 3 is moved or copied to a storage media of the electronic device 2 or to the storage unit 12 of the GPS logger 1 by the electronic device 2, the processing unit 15 may compare the time stamp in the file with the log time stored in the storage unit 12 and embed the position coordinate in the file, wherein the position coordinate corresponds to the log time closest to the time stamp.

It should be noted that the storage unit 12 may also store a coordinate embedding module, which may be a software for the electronic device 2 having superior calculating ability to embed the position coordinate in the file after the coordinate embedding module being load into the electronic device 2.

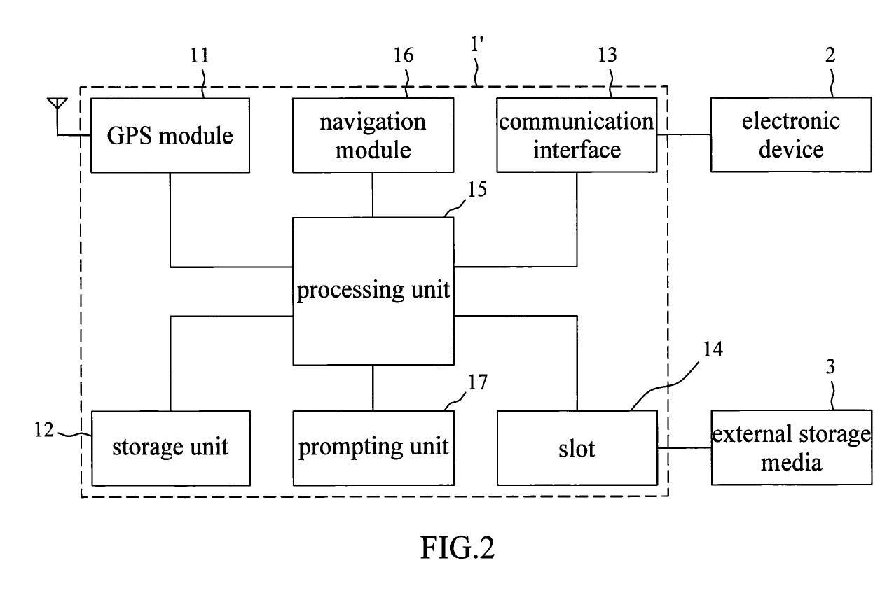

FIG. 2 illustrates another embodiment of the GPS logger 1′ according to the present invention, further comprising a navigation module 16 and a prompting unit 17. The navigation module 16 is electrically connected to the processing unit 15 for generating a navigation information according to a destination coordinate and a current position coordinate. For example, user may directly input a destination coordinate to the GPS logger 1′, alternatively, user may store a file including a position coordinate in the GPS logger 1′, and the processing unit 15 accesses the position coordinate in the file as a destination coordinate. The current position coordinate is the position coordinate generated by the GPS module 11 at the moment.

The prompting unit 17 is electrically connected to the processing unit 15 and configured for outputting the navigation information generated by the navigation module 16. For example, the navigation information including the distance between the destination coordinate and the current position coordinate and the direction of the destination coordinate with respect to the current position coordinate. In one embodiment, the prompting unit 17 comprises an audio output unit (such as a speaker or a horn), a display unit (such as a liquid crystal display) or a combination of the above. In another embodiment, the storage unit 12 may comprise a map information for the prompting unit 17 to show the map information and the navigation information while the GPS logger 1′ is navigating. Based on the combined map information, detailed navigation information is generated by the navigation module 16. For example, a road information suggesting whether the user should turn left or right at the intersection is generated according to the map information.

To sum up the foregoing descriptions, a GPS logger according to the present invention comprises a slot configured for an external storage media to electrically connect with the GPS logger and embeds a corresponding position coordinate in a file, stored in the external storage media, which is accessed. Therefore, the user may complete an operation of integrating the position coordinate with the file without extra operating procedures in computer. Furthermore, a GPS logger combining a navigation module and a prompting unit according to the present invention may perform either a simple navigation including direction and distance information, or an advanced navigation including map information.

While the invention is susceptible to various modifications and alternative forms, a specific example thereof has been shown in the drawings and is herein described in detail. It should be understood, however, that the invention is not to be limited to the particular form disclosed, but to the contrary, the invention is to cover all modifications, equivalents, and alternatives falling within the spirit and scope of the appended claims.

What is claimed is:

1. A global positioning system (GPS) logger comprising:
a GPS module configured for receiving a satellite signal and generating a log data including a position coordinate and a log time;
a storage unit configured for storing said log data;
a slot configured for an external storage media to electrically connect to said GPS logger, wherein said external storage media stores at least one file including a time stamp;
a communication interface configured for an electronic device to electrically connect with said GPS logger, whereby said electronic device exchanges data with said GPS logger via said communication interface; and
a processing unit electrically connected to said GPS module, said storage unit, said communication interface and said slot, wherein said processing unit is used for embedding said position coordinate in said file according to said log time and said time stamp when said file is accessed by said processing unit.

2. The global positioning system (GPS) logger according to claim 1, wherein said storage unit further stores a coordinate embedding module, whereby said position coordinate is embed in said file at said electronic device after said coordinate embedding module being load into said electronic device.

3. The global positioning system (GPS) logger according to claim 1, further comprises:
a navigation module electrically connected to said processing unit and configured for generating a navigation information according to a destination coordinate and a current position coordinate; and
a prompting unit electrically connected to said processing unit and configured for outputting said navigation information.

4. The global positioning system (GPS) logger according to claim 3, wherein said prompting unit comprises an audio output unit, display unit or a combination of the above.

5. The global positioning system (GPS) logger according to claim 4, wherein said audio output unit comprises a speaker or a horn.

6. The global positioning system (GPS) logger according to claim 4, wherein said display unit comprises a liquid crystal display.

7. The global positioning system (GPS) logger according to claim 3, wherein said storage unit further stores a map information and said prompting unit shows said map information and said navigation information while said GPS logger is navigating.

8. The global positioning system (GPS) logger according to claim 1, wherein said file is moved or copied to said electronic device or said storage unit.

9. The global positioning system (GPS) logger according to claim 1, wherein said storage unit comprises a flash memory or a hard drive.

10. The global positioning system (GPS) logger according to claim 1, wherein said communication interface comprises a wireless communication module or a Universal Serial Bus (USB).

11. The global positioning system (GPS) logger according to claim 10, wherein said wireless communication module comprises a wireless local area network, an ultra wideband or a Bluetooth module.

12. The global positioning system (GPS) logger according to claim 1, wherein said external storage media comprises a memory card.

13. The global positioning system (GPS) logger according to claim 1, wherein said file comprises a photograph or a film.
